(19) United States
(12) Patent Application Publication
(10) Pub. No.: US 2004/0053032 A1
(43) Pub. Date: Mar. 18, 2004

(54) Method for producing foam products

(76) Inventor: Rudolf Weingartner, Neuhfen a.d. Krems (AT)

Correspondence Address: WILLIAM COLLARD, COLLARD & ROE, P.C., 1077 NORTHERN BOULEVARD, ROSLYN, NY, 11576, US

(21) Appl. No.: 10/332,640

(22) PCT Filed: Jul. 6, 2001
(86) PCT No.: PCT/AT01/00222

(30) Foreign Application Priority Data
Jul. 11, 2000 (AT) A 1193/2000

(51) Int. Cl. B32B 3/26

(52) U.S. Cl. 428/304.4; 425/4 R; 425/140; 264/40.4; 264/45.1

(57) ABSTRACT

The invention relates to an apparatus (1) and a method for producing a product made from plastic foam flocks (3, 4), optionally using a binding agent. Production is operated in such a way that the total volume of a mould cavity (9) is divided into virtual individual volumes and plastic foam flocks (3, 4) are fed from supply containers (5, 6) to at least one measuring container on the basis of these individual volumes in order to determine the individual volumes or individual weights of these fractions.

The invention relates to a method and an apparatus and a measuring container for producing plastic foam products, as well as the plastic foam product produced, having the features out-lined in the introductory parts of claims 1, 14, 29, 33 and 34.

Ecological and economic reasons are prompting many companies to address the issue of “plastic waste recycling”. This can be achieved firstly by a process of hydration to make reusable secondary raw materials and secondly by applying a heat treatment to impart a new shape to thermoplastic materials. Another option is to crush recycled plastic and process the resultant particles with binders to make new products.

Along with others, the latter approach is the method of choice when it comes to plastic foam products. To this end, recycled plastic foam, whether it be made up of material produced in-house or recycled materials, for example from the automotive industry, is crushed to an appropriate grain size by mills, then mixed with a liquid foam-forming single-component or dual-component prepolymer and this mixture is expanded to a required shape, the interstitial spaces between the plastic foam particles being filled with the plastic foam newly formed from the prepolymer. A method of this type is known from patent specification DE 40 25 102 A1, for example.

The disadvantage of known methods of this type, however, is that there is a specific upper limit to the proportion by weight or volume of recycled plastic foam which can be added and this can not be exceeded. In said DE-A1, for example, an upper limit of 95% by volume is specified as being the proportion of plastic foam residues and/or plastic foam scrap which can be added, otherwise a sufficient adhesive bonding between the individual particles can no longer be guaranteed. The reasons why this is so are numerous. For example, it has not been possible to date to mix the plastic foam residues with the binding agents sufficiently thoroughly. Numerous attempts have been made to achieve this employing a whole variety of mixing apparatus. Patent specification U.S. Pat. No. 4,714,715 A, for example, proposes the use of a screw conveyor so that the polystyrene particles are mixed with other components, e.g. a melamine resin, as a binding agent, a propellant, a catalyst or similar, as they are conveyed and this mixture is then fed to an intermediate storage before being placed in a mould. According to the details given in the US-A, it is possible to work with mixtures containing 10 to 150% by volume of resin to 100% by volume of polystyrene particles.

Another less expensive approach known from the prior art, for example from patent specification DE 14 79 952 A, is to produce mouldings from plastic foam by adding fillers to the prepolymers. In order to obtain a homogeneous structure, this DE-A proposes a continuous process whereby the free-falling fillers are uniformly sprayed with the prepolymer.

Finally, a method of producing a moulding from flocks of plastic foam bonded with a prepolymer is known from patent specification EP 0 657 266 A, whereby this mixture is introduced into a mould at a predeterminable pressure and the mould has venting orifices to allow the gaseous medium to flow out and enable other reaction components to be introduced. Again, the proportion of plastic foam flocks in the overall quantity is limited to up to 90%.

The underlying objective of the present invention is to propose a method and an apparatus, by means of which an plastic foam product can be produced, which exhibits more homogeneous properties through its cross section. Another objective of the invention is to propose a method which enables the proportion of plastic foam flocks to be incorporated in composite plastic foam systems.

This objective is achieved by the invention, independently in each case, as a result of the features defined in the characterising parts of claims 1, 14, 29, 33 and 34. The advantage gained is that a method and an apparatus are provided, which enable fractions of volumetric weights to be determined very accurately in terms of the proportions contained in the finished plastic foam product, i.e. their weight or volume is measured and the data obtained is used to automatically make subsequent adjustments to the ratio of several fractions of volumetric weights relative to one another. As a result, whilst the strength of the plastic foam product remains constant, the proportion of binder needed can be reduced. Not only does this enable production costs to be reduced and help to protect the environment and resources of primary materials, it also reduces the amount of maintenance needed for the apparatus and its individual parts because the proportion of binder which cures prematurely in parts of the apparatus can also be reduced. Another advantage which can be achieved is that the properties of the plastic foam flocks used, in particular their volumetric weight, can be varied during continuous production without generating increased waste and without having to manually adjust the quantity introduced into the mould, because the desired volumetric weight for the plastic foam product can be obtained within a few cycles. It goes without saying that if plastic foam flocks of very different volumetric weights are used, at least one volumetric weight fraction must be of a volumetric weight below the desired volumetric weight and at least one volumetric weight fraction must be of a volumetric weight above it. This new method and this new apparatus also reduce the number of personnel required because, other than unforeseen problems, it is essentially only necessary to ensure that sufficient plastic foam flocks are available. In addition to being very clean, the method also enables plastic foam products of the same type with very standard properties, in particular volumetric weights, to be produced on a mass scale, whilst at the same time reducing waste caused by customer complaints.

Advantageous embodiments of the method proposed by the invention are defined in claims 2 to 13.

As a result of the embodiments defined in claims 2 to 10, the method can be readily adapted to the specific plastic foam products to be produced, in particular the specific moulds used to form the plastic foam products, to the degree that under certain circumstances, not only is the need for additional binding agent dispensed with, additional improvements can also be made in terms of reducing contamination of parts of the apparatus and obtaining more standardised plastic foam products, due to improved filling of problem areas of the mould.

As a result of the embodiment of the method defined in claim 11, the part-volumes of the weighing container can be more reliably and adequately filled without the over-metered proportion of the quantity being taken into account when determining the weight or volume of the contents of the part-volume.

Claim 12 defines another embodiment whereby the plastic foam flocks and/or the mixture of plastic foam flocks and binding agent are metered into the mould with a star feeder. Consequently, constant and defined volumes of plastic foam flocks, optionally admixed with binder, are always introduced into the mould, which obviates the need for weighing the mixture again as it is introduced.

Claim 13 defines another possible variant of the method, the advantage of which is that because the binder can be metered very accurately, other properties of the material, in particular the hardness, can be set so that they remain very uniform for plastic foam products of the same type during batch production.

Again, the advantage of the embodiments defined in claims 15 to 17 is that the process of defining the volumes or weights of the plastic foam flocks can be improved.

An embodiment of the apparatus defined in claim 18 is also of advantage and enables the material properties of the plastic foam flocks to be taken into account, enabling thorough mixing in the apparatus.

An embodiment defined in claim 19 has proved to be of particular advantage since it enables better standardisation of the mixture to be produced.

The ready mixture is metered into the mould in a very straightforward and very accurate fashion as a result of the embodiment of the apparatus defined in claim 20.

By admixing the binding agent in the manner defined by the embodiment described in claim 21, the binding agent is very finely distributed through the mixture of plastic foam flocks.

Other possible embodiments of the apparatus are defined in claims 22 to 24, which avoid brief halts in production caused by an inadequate supply of secondary raw materials.

The apparatus can be simplified by means of the design described in claim 25 because the binding agent is sprayed directly into the mould, thereby avoiding any premature curing of the binding agent and hence contamination of equipment parts.

Mould cavities with complex geometries are uniformly filled as a result of the embodiment of the apparatus defined in claim 26.

The apparatus as a whole can be simplified as a result of the embodiment of the apparatus defined in claim 27.

Providing a measuring unit on the measuring container at all times means that it is automatically detected when the full level is reached and the introduction of plastic foam flocks into the measuring container can be automatically interrupted, as described in claim 28.

Finally, claims 30 to 32 describe embodiments which are of advantage because the composition, and hence the product properties, is accurate.

Other embodiments of the plastic foam product proposed by the invention are defined in claims 35 to 39 and the related advantages may be found in the description.

To provide a clearer understanding, the invention will be explained in more detail with reference to the embodiments illustrated in the appended drawings.

Of these:

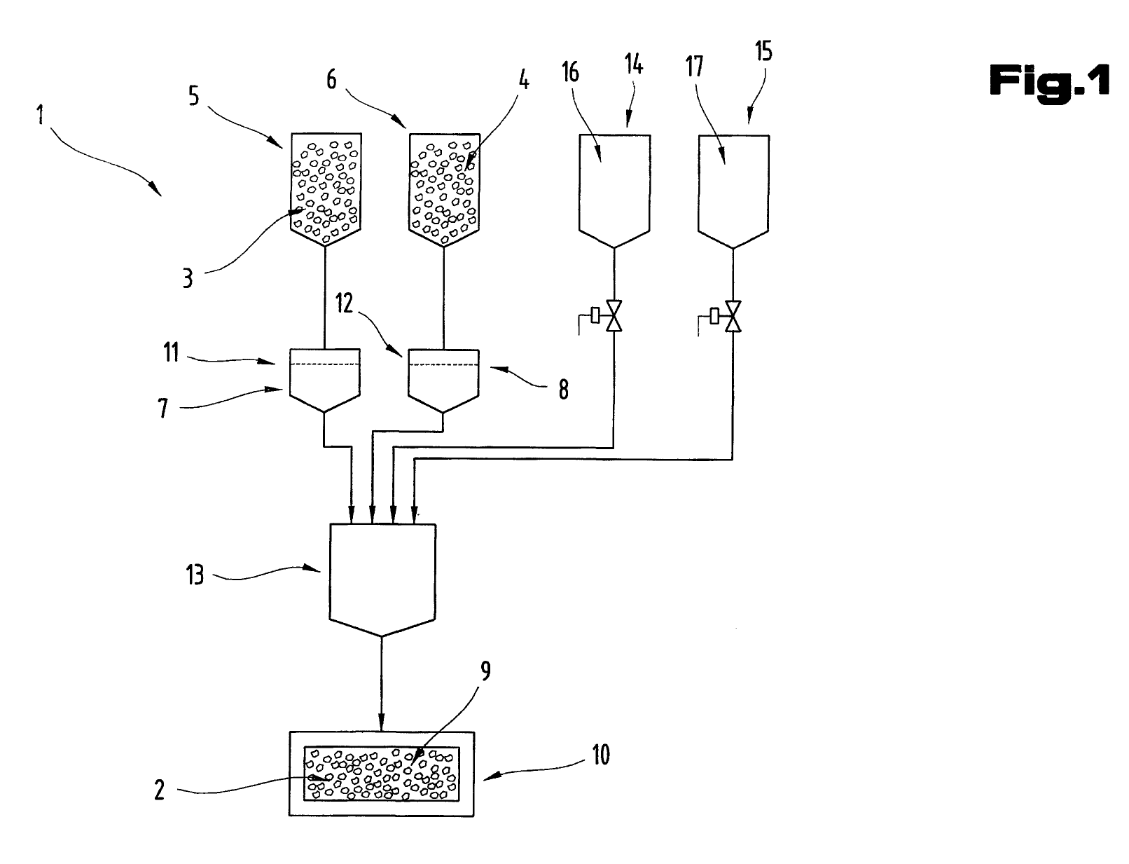

FIG. 1 is a simplified, schematic diagram of an apparatus as proposed by the invention;

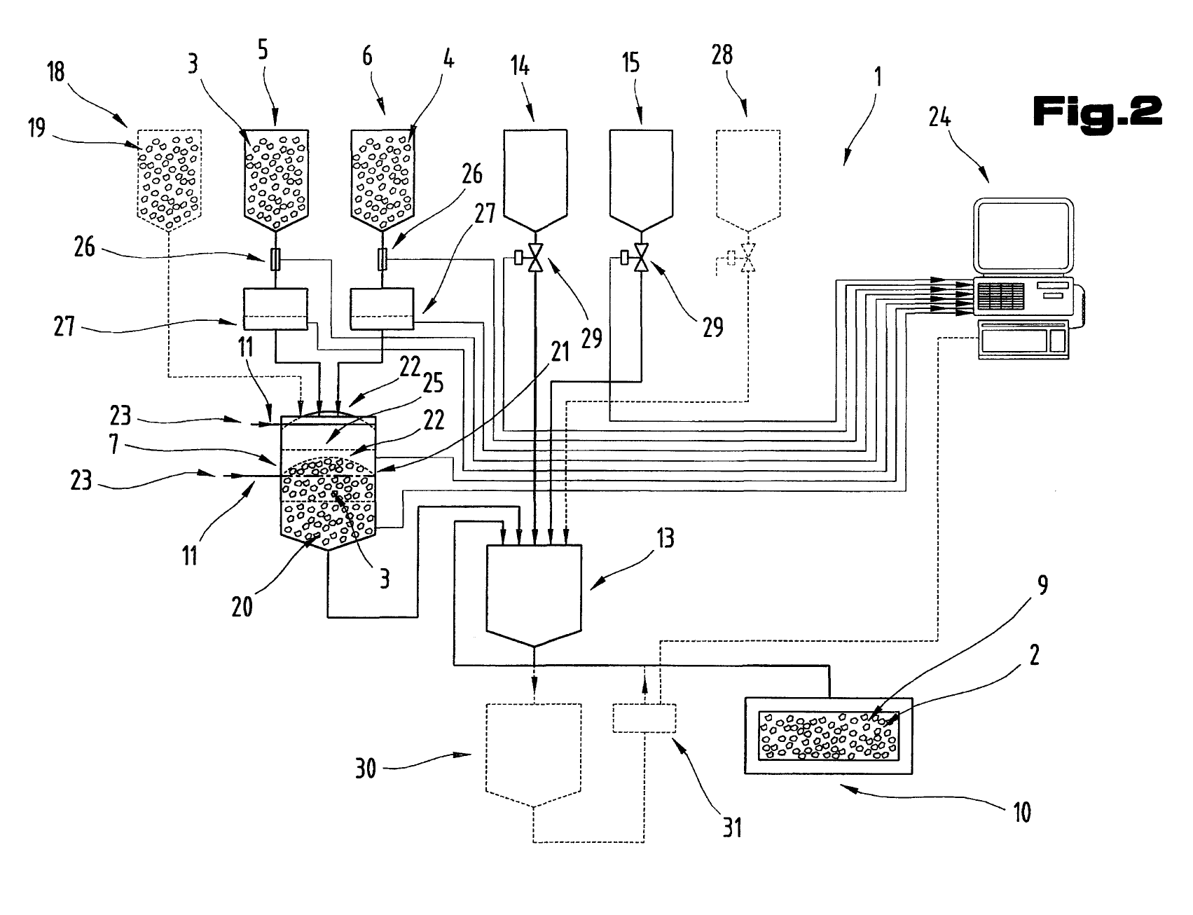

FIG. 2 is a simplified schematic diagram showing another embodiment of the apparatus illustrated in FIG. 1;

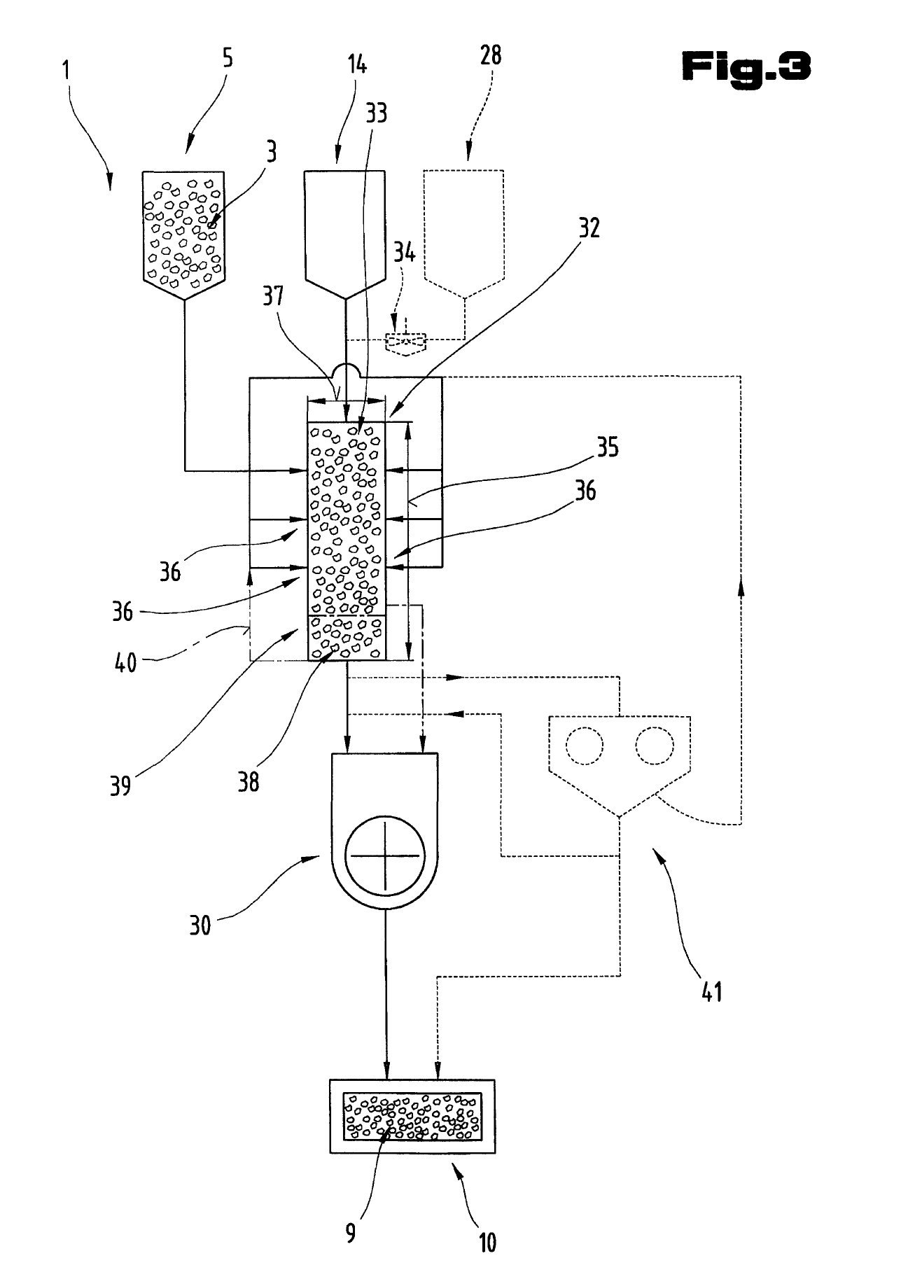

FIG. 3 is an embodiment of the apparatus proposed by the invention with a free-fall mixing screw;

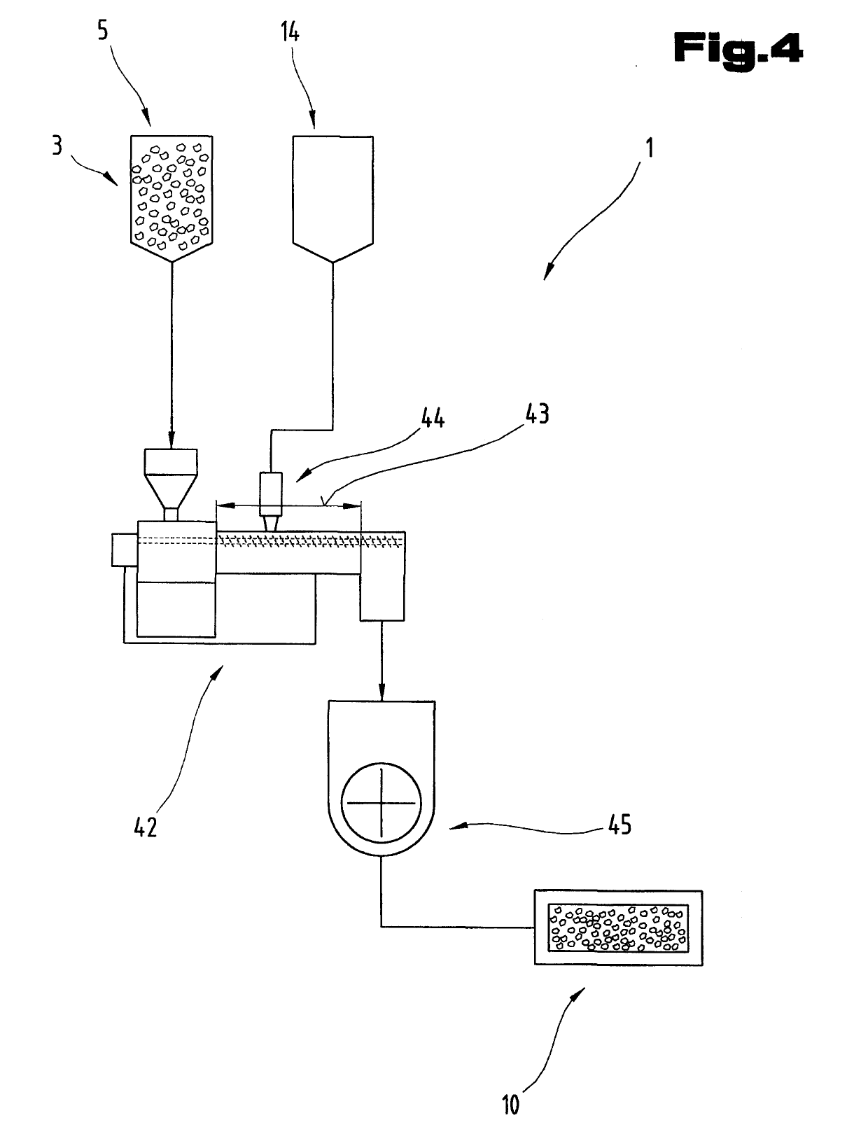

FIG. 4 is a simplified schematic diagram of an embodiment of the apparatus using a screw mixer;

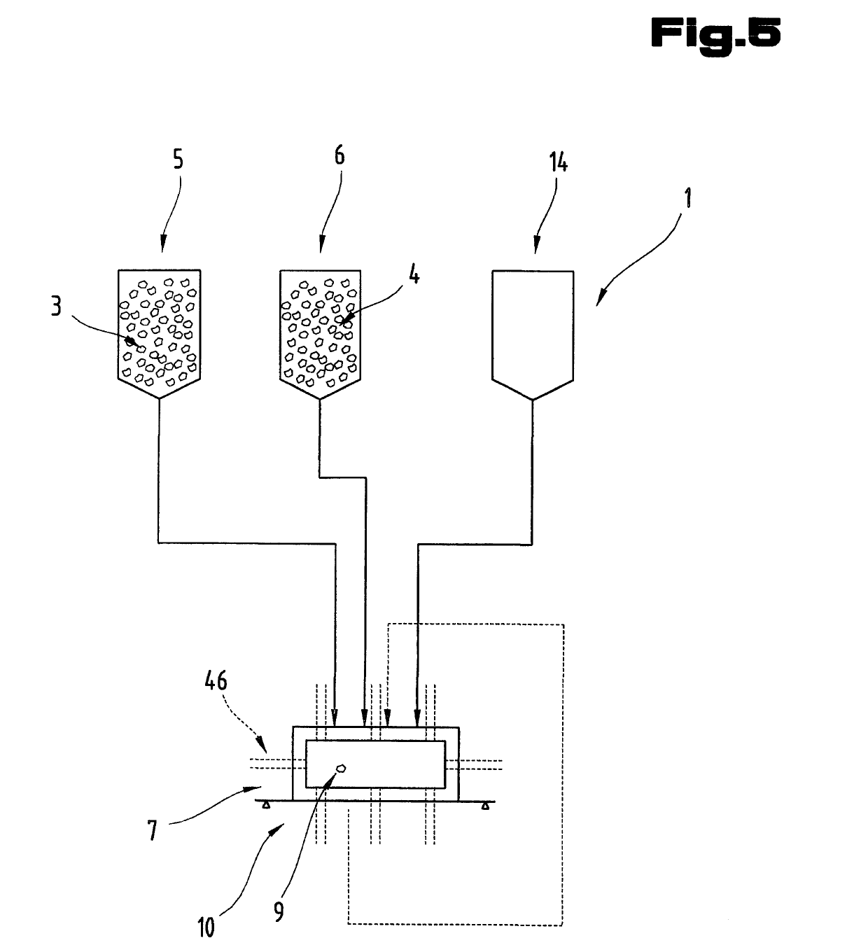

FIG. 5 is a simplified schematic diagram of an embodiment of the apparatus using the mould as a weighing system.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc,. relate to the drawing specifically being described and can be transposed in terms of meaning to a new position when another position is being described. Individual features or combinations of features from the different embodiments illustrated and described may be construed as independent inventive solutions or solutions proposed by the invention in their own right.

The method proposed by the invention may be used to produce objects made from plastic foam, e.g. mouldings, blocks of foam, etc., using recycled plastic foam, which exhibit primarily standard properties through their cross section and their volume. Recycled plastic foam is intended to mean not only materials obtained through the recycling circuit, i.e. used products, such as generated by the automotive industry, packaging plastics or similar, but also waste generated in the actual production chain, e.g. when trimming mouldings, such as cushions, mattresses, sound insulation elements, cladding elements or similar. Naturally, however, it would also be possible to use plastic foams from primary material, in other words new plastic foams specifically made for this purpose.

By standard properties is meant that there will be a certain narrow range of variation in these properties that will naturally occur due to the production method. This is attributable, for example, to the fact that recycled plastic foams from a variety of sources are used, which means that the volumetric weight, for example, may vary through the cross-section, i.e. from foam particle to foam particle.

Naturally, it would also be possible to use the method proposed by the invention to produce mouldings with a higher volumetric weight in certain regions, for example. This might be the case if meeting static requirements, for example, where these regions are to be used to assemble the mouldings and therefore need to be of a higher strength to prevent them from being torn out. The higher volumetric weight can then be achieved by compacting these regions more firmly, for example, and by packing a larger quantity of foam particles into these regions. The properties will then naturally vary when viewed in cross section but the essence of the invention can still be implemented in these parts on the basis of pure calculation.

Naturally, it would also be possible to provide the products proposed by the invention with reinforcing elements in a manner known from the prior art, such as bars, non-woven fabrics or similar, for example, on their top faces or in their body and it is also possible to apply layers of facing or similar, for example. In terms of preferred materials, for example, recycled polyurethane soft plastic foam, recycled polyurethane hot and/or cold formed plastic foams, recycled polyurethane soft plastic foams covered or faced with textiles and/or films, recycled polyurethane composite foams as well as rubber granulates or cork granulates may be used. Apart from these, other plastic foams could also be used, e.g. polyolefin foams, polyamide foams or similar. This being the case, other thermoplastic recycled products and/or natural and/or synthetic fibres of various lengths may be added to the materials listed above to produce plastic foam objects.

For the purposes of the method, the various recycled plastic foams are crushed to a specific particle size, which may be in the range of between 2 mm and 20 mm, for example. Although particles of this size range are preferred, it would also be possible to use bigger or smaller particles, e.g. in the range of between 1 mm and 30 mm, without departing from the scope of the invention.

In order to produce a standard product from the plastic foam particles, there are various possible options for binding the particles with one another. One option is to admix a certain quantity of a prepolymer with the plastic foam particles, for example. This being the case, the quantity may be in the range of between 1% by weight and 20% by weight, and the method proposed by the invention advantageously also enables proportions of between 1% by weight and 5% by weight, preferably between 2% by weight and 4% by weight, in particular 3% by weight to be used, which advantageously reduces the cost of primary raw materials, whilst reducing the drain on resources of primary materials.

Naturally, the proportions of added prepolymer may be higher than 5% by weight relative to the total mixture and may be in the range of from 6% by weight to 8% by weight.

As will be explained in more detail below, the prepolymer may be admixed in a whole variety of ways.

The prepolymer may contain one or more components, for example. In the case of polyurethane, for example, it would be possible to use mixtures of a polyol with a polyisocyanate or single-component polyurethane resins.

In addition, it is also possible to use 100% plastic foam particles and dispense with binding agent, in which case the surface of the plastic foam particles will be heated by increasing the temperature, for example by means of warm or hot air, enabling a reciprocal fusion of the foam particles. The advantage of this approach is that not only does it obviate the need to use binding agent, it also means that there is no need for additional mixing apparatus, which would otherwise be soiled to a certain degree. It will also enable high volumetric weights to be obtained in the finished products, whilst simultaneously improving the energy requirements of the plant as a whole. However, particular attention must be paid to the fact that, under certain circumstances, the plastic foam particles emanate from a varied range of sources and thus behave differently at different temperatures, as well as the fact that, when they are taken out of the moulds, the finished products will be at a higher temperature than they would be if they had been produced using binders. However, it is possible to recycle the energy, for example by making use of a heat exchange of the heated air in the premises in which the finished products are cured, for example. If using this method, it is an advantage to use mould release agents in the mould, in order to reduce maintenance and cleaning requirements.

Another option is to cause the surface of the plastic foam particle surface to enter into a chemical reaction with a gas by glycolysis, the advantage of which, again, will be that no additional binder is necessary, in addition to simplifying the structure of the machinery. However, because of the reaction gas, it will be necessary to use gas-tight moulds.

FIG. 1 illustrates an apparatus 1 proposed by the invention for producing plastic foam products 2 from plastic foam flocks 3, 4. The latter are preferably held in readiness in supply containers 5, 6. Not illustrated in FIG. 1 is the crushing equipment, which might be provided in the form of mills, cutting or tearing machines, for example, by means of which the recycled plastic foams constituting the secondary raw material are crushed and which are connected upstream of the supply containers 5, 6. All of the systems known from the prior art may be used as crushing apparatus and a system of screening based on particle size may also be used.

Naturally, however, it would also be possible for the crushing apparatus to be disposed downstream of the supply containers 5, 6, for example as a means of operating an additional crushing process or to operate crushing on what is known as a “just in time” basis, i.e. in the latter case, supplies of coarser recycled foam plastics would be held in readiness in the supply containers 5, 6.

Next on the production line after the supply containers 5, 6 are measuring containers provided in the form of weighing containers 7, 8.

The idea of weighing plastic foam flocks for producing composite foams prior to moulding is known from the prior art, e.g. from patent specification EP 0 657 266 A. Until now, this weighing process has been operated by completely filling the relevant container and working out a volumetric weight on the basis of the volume of this container, which leads to a greater or lesser margin of fluctuation. The result of this approach has been that, because there is no possibility of determining exactly the volumetric weight of the plastic foam particles used, it has always been necessary to work on the basis of a certain degree of safety in terms of the prepolymer used as the binding agent, i.e. metering is based on an excess quantity of prepolymer.

With the apparatus 1 proposed by the invention, it is now possible to operate in such a way that plastic foam flocks 3 held in readiness in the supply container 5 are at least predominantly of a different volumetric weight than the plastic foam flocks 4 held in the supply container 6. This is usually achieved by using recycled plastic foams from a variety of sources. The two volumetric weights of the plastic foam flocks 3, 4 in the supply containers 5, 6, i.e. the volumetric weight fractions of plastic foam flocks 3, 4, obtained by using plastic foam flocks 3, 4 of different origins, are measured so that a desired volumetric weight of the plastic foam product 2 falls in between these two volumetric weight fractions. The weighing containers 7, 8 are designed in such a way that they are always kept filled with a constant volume and the sum of the two volumes is preferably selected so that it matches the volume of a mould cavity 9 of a mould 10 or a multiple thereof. In view of the fact that the filling process does not usually operate in such a way that the weighing containers 7, 8 are filled with a predetermined volume in an identical manner, it is expedient, prior to weighing, to take appropriate steps to set this predetermined volume and ensure that this predetermined volume is not exceeded during the filling process with plastic foam flocks 3, 4. Allowance may be made for the fact that the predefined volume is not completely filled during subsequent cycles. For example, after filling the weighing containers 7, 8, the level of the contents at the point of the median axis of the container may be higher than it is at the side walls of the weighing container 7, 8. In order to get rid of this piled-up quantity of plastic foam flocks 3, 4 and ensure that it is not weighed with the rest, it is possible, as indicated by broken lines in FIG. 1, to push separating mechanisms, e.g. slides 11, 12, into the weighing containers 7, 8, in which case the position of these slides 11, 12 is selected and the weighing containers 7, 8 preferably filled to the degree that a level top surface is obtained at the filling level after pushing in the slides 11, 12, essentially corresponding at least to the underside of the slides 11, 12. To ensure that the separated part of the plastic foam flocks 3, 4 is not weighed with the rest, it is possible for the part of the weighing containers 7, 8 lying above the slides 11, 12 to be uncoupled so that the end effect will be that a constant volume of content of plastic foam flocks 3, 4 will actually be weighed.

Naturally, there are other methods of achieving this constant volume and one option would be, for example, to blast air into the weighing containers 7, 8 and obtain an even distribution of the plastic foam flocks 3, 4 in this way, thereby keeping the surface of the filled quantity level.

The volumes of the weighing containers 7, 8 are advantageously split in a 1:1 ratio in terms of the volume of the mould cavity 9, i.e. each is filled with 50% of the volume of plastic foam flocks 3 and 50% of the plastic foam flocks 4. Naturally, it would be possible to vary this ratio, particularly during subsequent production cycles, if it is found that the requisite desired volumetric weight of the finished plastic foam product 2 will not be achieved on the basis of this volume ratio and the associated volumetric weight. Another way of varying the volume ratio would be to still keep the volumes of the weighing containers 7, 8 constant but vary the actual volume that is filled with plastic foam flocks 3, 4.

On the other hand, it would naturally also be possible to leave the volumes constant and instead fill them with a higher volumetric weight of plastic foam flocks 3 or 4 by applying pressure to the weighing containers 7, 8, for example.

An expedient approach has been found to be that of filling both weighing containers 7, 8 in an identical manner in a first step and determining the resultant overall volumetric weight of the plastic foam product 2, and then, depending on how the plastic foam flocks 3, 4 are to be bonded with one another, also take account of the proportion of binding agent.

After this first cycle, the variance of the actual volumetric weight from the required desired volumetric weight for the plastic foam product 2 is determined and then the required weights or volumes are determined for each of the plastic foam flocks 3 and 4 that will be needed to obtain it. Using an interpolation method of this type will enable the volumetric weight of the finished plastic foam product 2 to be set up within a few cycles, for example three to four, on a fully automated basis, e.g. by means of a central control and command system, in particular an EDP controller, so that any variances from the desired volumetric weight required for the plastic foam product 2 are kept very negligible. However, it would also be possible to apply any correction needed for the same plastic foam product 2 by removing a part of the surplus plastic foam flocks 3, 4 of a volumetric weight fraction or by increasing the proportion of whichever volumetric weight fraction has been found to be too low or by adjusting the quantity or volume of the two volumetric weight fractions both by an increase or reduction as necessary. Consequently, the latter can be very accurately metered, especially as there is no need for any additional safety margin for the binding agent, and the proportion of binding agent in the plastic foam product 2 reduced in this way.

Another advantage of this approach is that it offers the possibility of using any secondary raw materials, i.e. plastic foam flocks 3, 4, during production, and by any is meant in particular differing, i.e. varying, volumetric weight, and still achieve the correct quantity of plastic foam flocks 3, 4 needed to fill the mould cavity 9 without any manual readjustment and, here too, an automatic readjustment can be operated within a few cycles.

Naturally, the filling level in the weighing containers 7, 8 may also be measured on an automatic basis, for example by a computer-assisted method, and when a pre-set level is reached, the introduction of plastic foam flocks 3, 4 into the weighing containers 7,8 is interrupted. To this end, appropriate measuring units may be mounted on the weighing containers, for example light beams, which can be set up to halt the introduction of plastic foam flocks 3, 4 if they are broken for a period of time.

After weighing, the plastic foam flocks 3, 4 are transferred to a mixer 13. If using binding agents, these can be transferred to this mixer 13 from appropriate supply containers 14, 15 at the same time. As mentioned above, both single- and dual-component binding agents may be used, in which case the number of supply containers 14, 15 will be selected accordingly and it is therefore not necessary to stick to the two supply containers 14, 15 illustrated in FIG. 1 to operate the apparatus 1 proposed by the invention.

If using polyurethane foam flocks, the binding agent may be made up of a prepolymer of polyol 16 held in the storage container 14 and a polyisocyanate 17 held in the supply container 15. This will enable a polyurethane foam of a known type to be produced between the plastic foam flocks 3, 4, in which case the foaming process may be one known from the prior art, e.g. using a reaction medium, such as water, as a propellant and/or by introducing heat, e.g. by means of steam.

A whole variety of mixers 13 may be used in the apparatus 1 proposed by the invention, as will be explained in more detail below. For example, the mixer 13 might be a so-called static mixer, i.e. one which is operated without any moving parts. To this end, a whole range of accessories may be mounted in the mixer 13 to change the direction of the plastic foam flocks 3, 4 as they are conveyed along the route through the mixer 13. The conveying system may be operated with air, for example. Alternatively, it would naturally also be possible to use continuous conveyors, for example vibrating conveyors, belt conveyors, etc.

Another option would be to provide any one of a number of stirring mechanisms in the mixer 13, by means of which the plastic foam flocks 3, 4 would be distributed on the basis of static curves, especially when mixing plastic foam flocks 3, 4 of different volumetric weights with one another.

Naturally, another possibility would be to provide the apparatus 1 with other mixers 13 with moving parts. For example, it would be possible to use mixers 13 with one or more mixing blades on at least one shaft. This mixing blades may be designed so that they are connected to one another, thereby providing a screw-type mixer 13. If using screw mixers, it will be possible to provide several mixer shafts, e.g. two arranged adjacent to one another, and operate them in the same or opposite directions. Furthermore, in the case of screw mixers, it is also possible to provide several screw channels on one shaft, for example two, in which case these screw channels may be designed so that at least one conveys the mixed material outwards, i.e. towards the side walls of the mixer 13, and the second screw channel conveys the mixed material towards the central axis, i.e. inwards.

Advantageously, mixers of this type with mixing screws disposed on a shaft, where one has an outward conveying action and the other an inward conveying action, have been found to produce a good mixing quality, i.e. as homogeneous as possible a distribution of prepolymer and plastic foam flocks.

Other known types of mixers may also be used and, moreover, the apparatus 1 proposed by the invention may be provided with several mixers 13, for example in order to produce a coarse mixture, e.g. prior to admixing with the binding agent. However, at least one other mixture could be provided downstream of the mixer 13, in the production direction.

Other than as illustrated by the embodiment of FIG. 1, the plastic foam flocks 3, 4 can be mixed with the binding agent at any number of points of the apparatus 1. Accordingly, the mixing may take place in the pipe used to fill the mould, not illustrated in FIG. 1, and, if air is used to convey the plastic foam flocks 3, 4, mixing may also take place in the blower conveyor. Otherwise, if using a two-component binding agent, the arrangement can be split, as illustrated in FIG. 1, in terms of delivering the individual components to the mixing system.

For example, a first component, e.g. the polyol 16, could be mixed with the plastic foam flocks 3, 4 in the filling tube and a second component, e.g. the polyisocyanate 17, might be mixed at a later stage in the tool, i.e. in the mould 10. This could be operated in the form of a sprayed mist or similar, for example. The advantage of using a mixing system of this type is that the material properties would be uniform and it would also ensure better filling of problem areas of the mould 10, i.e. areas that are not easy to reach during the filling process. Furthermore, no additional mixers 13 would be needed, which would avoid premature setting of the binding agent, and there would be less soiling of the apparatus 1 as a whole, which in turn will reduce the amount of maintenance required for the apparatus 1.

If using an input screw to fill the mould 10, the mixing process can take place in it, which again will produce more even material properties and obviate the need for additional mixers. Another advantage of this embodiment is that the apparatus 1 can be of a simpler design, again avoiding the problem of cured material being left in various places that are not directly upstream of the mould 10 in the process sequence.

If the plastic foam flocks 3, 4 are mixed in the tool, i.e. in the mould 10 in this particular instance, it will be possible to provide the metering system in the form of needle injection, for example, in which case it will be possible to mix in the steam and/or water needed for expanding the primary raw materials at the same time, e.g. for polyurethane expanded foams. The metering may be organised through bores in the tool. Again, this will make the structure of the apparatus 1 simpler and a majority of the elements making up the apparatus 1 can be largely kept free of undesirable contamination.

In another method, the plastic foam flocks 3, 4 and/or binding agent are electrically oppositely charged, which means that an electrostatic mixing process can be operated. This will ensure an even admixing of the raw materials whilst simultaneously reducing the binding agent. The materials may be charged using methods known from the prior art, e.g. of the type used in dust removal systems.

The binding agent may also be used in powdered form, and this powder may again contain one or several components. By opting for dry mixing, there will be no need to provide nozzles for the binding agent, thereby reducing the degree of soiling created in the apparatus 1 due to premature setting of the binding agent.

As already mentioned above, it is also possible to dispense with an additional binding agent, for example by heating the surface of the plastic foam flocks 3, 4, e.g. with warm or hot air, which will cause the plastic foam flocks 3,4 to melt. Alternatively, however, another option would be to transform functional groups, e.g. hydroxide groups, optionally increasing the temperature, in the surface region with reactive gases, to the point where the individual plastic foam flocks will bond with one another directly.

The method proposed by the invention will also offer advantages if operated using these last two embodiments described above. Although this option no longer carries the advantage of being able to further reduce the proportion of binding agent, it is nevertheless possible to use several individual fractions relative to the overall volume of the tool, by measuring the weight, which will produce very standard volumetric weights for plastic foam products 2 of the same type, and again it will enable the ratio of the fractions of plastic foam flocks 3, 4 of different volumetric weights to be varied in order to adjust to the desired volumetric weight.

Even if using plastic foam flocks 3, 4 of a relatively standard volumetric weight, the method and the apparatus 1 proposed by the invention still offer the advantage that with this particular type of metering, especially the weighing process, it will also be possible to make allowance for considerable differences in flock sizes, such as usually occur when crushing secondary raw materials, which means that the process of screening the plastic foam flocks 3, 4 can also be dispensed with if necessary.

As mentioned above, the ready mixture of plastic foam flocks 3, 4 and binding agent is then introduced into a tool, e.g. a mould 10. This mould 10 may be designed to produce so-called block foam or moulds 10 may be used which already have the final contours of an expanded plastic foam product 2. In other words, mouldings can be produced using this approach.

At this stage, it should be pointed out that the method and the apparatus 1 proposed by the invention may also be used in continuously operating foaming plants to produce block foams, of the type known from the prior art.

Again, a whole range of methods may be used to fill the moulds 10 and the selected methods merely have to be configured to fit in with the overall design of the apparatus 1, although allowance can also be made for the specific plastic foam products 2 to be obtained. Accordingly, for example, one option would be to use a spiral or screw system for filling the mould 10. For this purpose, a screw conveyor would then be disposed downstream of the mixer 13 and upstream of the mould 10. The advantage of using a filling system of this type is that the air vented from the mould 10 can be reduced to a level lower than the level of the air used for filling, which will largely avoid dust being carried out of the tool. This type of filling system can advantageously be used with apparatus 1 of the type which is not used for producing a high daily output.

In another variant of the method, a plunger system is used for filling purposes. To this end, an appropriate container, e.g. filler container (not illustrated in FIG. 1) is disposed upstream of the mould 10, the capacity of which is preferably the same as the volume of the mould cavity. However, it is not absolutely necessary to keep to this ratio of volumes. For example, it would be possible to introduce a bigger volume of the filling mixture into the filler container, which would guarantee that the whole of the mould would be filled, even if parts of the mixture are left behind in the filler container. Alternatively, it would also be possible to produce plastic foam products 2 with higher degrees of compaction, by filling the mould with a free-foaming volume, i.e. a volume of plastic foam flocks 3, 4 admixed with binding agent in the uncompressed state, and, before expanding the binding agent or generally initiating the reaction of the binding agent with the plastic foam flocks 3, 4, as is the case, to compact at least individual regions of the mould 10, e.g. by displacing different mould faces or regions of these mould faces. In terms of the quantity, a finished mixture may be prepared so that the weight is in the range of between 3 and 15%, preferably between 5 and 10%, above the weight needed to fill the mould completely, for example. The advantage of using a filling system based on a plunger is that metering of the quantities can be improved in the case of finished plastic foam products 2 of higher volumetric weights, as well as the fact that the mould 10 can be filled more quickly than if using spiral or screw filling systems. If it happens that the mould 10 is not uniformly filled using the plunger filling system, for example in the corners or peripheral regions of the mould 10, the filling mixture can be evened out before the binding agent sets by blasting in air, for example.

As mentioned above, another possibility is to use a flow of air to convey the mixture of plastic foam flocks 3, 4 and binding agent and the mould 10 can be filled in this manner.

If using this method of filling the mould, the mould 10 may have several outlet orifices for the conveying air, as a result of which the raw material mixture, in other words the quantities of plastic foam flocks 3, 4 mixed with the prepolymer, can be kept in a virtually hovering state during the filling process, thereby preventing any inadvertent premature compaction in the regions of the mould 10 lying opposite the inlet openings, at least to a large degree.

Conversely, the mixture can be introduced into the mould cavity 9 by applying a vacuum. This enables the mould 10 to be filled very quickly. Furthermore, a filling method of this type enables the problem areas of the mould 10 mentioned above to be more reliably filled, as well as making cleaning of the filling tool and the mould 10 easier.

The filling process may also be operated in several steps. Consequently, the filling process can be interrupted, for example to place reinforcing parts or similar in the mould.

The filling process may naturally also be operated using several filling orifices, in which case shorter filling pipes can be used. Furthermore, another possibility, e.g. if using several filling pipes, is to allow them to open into as big a filling orifice as possible, which will also enable the mould to be filled very quickly, thereby ensuring a high daily output.

Apart from or in addition to using the filling containers described above as a means of metering a specific quantity or a specific volume of ready mixture into the mould 10, it would also be possible to use a star feeder for filling purposes, e.g. with the tool open. This enables a very standard quantity control to be achieved and provides a very simple means of filling the mould 10 in stages.

Finally, it should also be pointed out that manual filling would also be feasible, for example if parts of the mould have complicated contours.

As mentioned above, the hardening process can be operated in various ways depending on the type of binding agent used, e.g. by adding water or steam and/or increasing the temperature and/or applying pressure, and once the binding agent has set, the finished plastic foam product 2 is optionally removed from the mould after a certain settling time, after which it can be forwarded to any other processing steps known from the prior art which might be needed, or the plastic foam product 2 can be sent for storage until despatch.

In the first embodiment described above, the volumetric weight of the plastic foam products 2 is standardised due to the fact that the ratio of different volumetric weight fractions of plastic foam flocks 3, 4 is specifically configured by weighing the individual fractions relative to one another and in particular with a view to achieving the desired volumetric weight.

In another embodiment of the invention, it is possible, rather than aiming to produce a constant volume in the weighing containers, to work towards maintaining a constant weight of plastic foam flocks 3, 4 and determine the volume in this way. In a manner similar to that used for the first embodiment, a very standardised volumetric weight of the plastic foam products 2 can be achieved by varying the volume. In the same way as with the first embodiment, the specified volumes can be processed with the aid of an EDP-assisted system, which will calculate the proportion of binding agent which needs to be measured out. The relevant quantity needed to fill the mould 10 can then be mixed in a separate mixing container with the binding agent and it has proved to be of advantage if the ready mixture is then held in an intermediate container before the mould 10 is filled. In order to determine the individual volumes, containers may be used which have various measuring units disposed on their external surface in order to detect when the filling level is reached. Alternatively, it would be possible to use height-adjustable measuring units. This will again ensure level filling, i.e. a flat top surface instead of a mound, and the top surface can be levelled by blasting in air, for example, or alternatively by separating off the uppermost layers of the plastic foam flocks 3, 4 in the measuring containers. Naturally, it would also be possible to obtain a standard filling height using a combination of air blasting and simultaneous displacement of a container cover.

Although this far, the description has always referred to two different fractions, it would equally be possible to use several fractions, whether they are of different weights and/or volumes, to produce the plastic foam products 2.

FIG. 2 illustrates another embodiment of the apparatus 1 proposed by the invention.

Again, several supply containers 5, 6 for the plastic foam flocks 3, 4 may be provided and additional supply containers 18 may also be provided for plastic foam flocks 19 or similar, as indicated by broken lines.

The difference as compared with the embodiment illustrated in FIG. 1 essentially resides in the fact that, rather than using a separate weighing container 7, 8 for each supply container 5, 6, 18, as in the case illustrated in FIG. 1, the individual fractions are delivered to a common weighing container 7. Any number of methods may be used to convey the plastic foam flocks 3, 4, 19 to the weighing container 7, and a pre-metering system may be operated using a star feeder gating system. However, it would also be possible to use screw conveyors, belt conveyors, air conveyors or similar.

As indicated by broken and dotted-dashed lines in FIG. 2, the weighing container 7 may be divided up so that the method can be implemented by operating a first step, for example, in which a bottom region 20, which may extend as far as the dotted-dashed line 21, can be filled so far with plastic foam flocks 3 from the supply container 5, and once a mound 22 has been separated off, again by means of a slide 11 for example, indicated by arrow 23, the entire bottom region 20 is at least more or less filled with foam flocks 3.

The mound 22 is therefore separated by pushing the slide 11 into the weighing container 7 after filling the bottom region 20, thereby always ensuring a predeterminable volume, which may correspond to half the volume that can be processed in each mixing process, i.e. mixing with the binding agent and in particular the prepolymer, for example, is held in readiness for weighing out the plastic foam flocks 3 contained therein.

Consequently, the weight of the contents in this region 20 is determined and the result forwarded to a data processing system 24, for example. Advantageously, the region 20 in which the weight of the contents is known can be kept separate from the rest of the supply container, in particular by mechanical means, for example it can be kept separate from the upper region of the weighing container 7 by being displaceable relative to this upper region 25 of the weighing container 7, to prevent the mound 22 from being weighed with the rest, for example. Then, as described above, an upper region 25 is filled with plastic foam flocks 4 from the supply container 6 and the relevant data is again forwarded to the data processing system 24, where it is used to finally determine the mixing ratio for the next mixing process, naturally by reference to the desired volumetric weight of the plastic foam product 2. The mound 22 of plastic foam flocks 3 can be at least partially removed from the weighing container 7 before filling the region 25 or alternatively, the second fraction of plastic foam flocks 4 from the supply container 6 may be allowed to “contaminate” these foam flocks 3, in which case they will also be weighed in the second weighing process to determine the weight of the contents of the region 25. It is possible to determine the weight or volume of the second volumetric weight fraction both separately from the first or jointly with it. In the latter option, the slide 11 is removed again so that the second volumetric weight fraction drops directly down onto the first.

Although dropping the top region 25 directly down onto the bottom region 20 of the weighing container 7 causes a problem insofar as the plastic foam flocks 3 in the bottom region 20 are subjected to a certain degree of compression due to the natural weight of the foam flocks 3, 4 in the weighing container 7 as a whole as far as the volume of the weighing container 7 is concerned, thereby “distorting” the top region 25 due to the give of the plastic foam flocks 3 in the bottom region 20, which means that ultimately, the proportion of plastic foam flocks 4 in the overall mixture comprising plastic foam flocks 3, 4 is excessive by a specific percentage by reference to the total mixture of plastic foam flocks 3, 4, it is nevertheless possible to make allowance for this initial compression and the resulting distortion to the measurement result using calculations, for example with the aid of the data processing system 24, and work out an appropriate correction factor so that the top region 25 can be filled accordingly by applying this correction factor.

Another advantageous option, mentioned above, is to fill the weighing container 7 with the part volumes, of which there are 2 for example, needed to make up the volume to be processed in the mixer 13 and then remove them after weighing, which means that the problem of the plastic foam flocks 3 being compressed when the top region 25 is filled with plastic foam flocks 4 does not arise with this embodiment. The added advantage which this brings is that the weighing container 7 can be of a reduced size, especially as not all the volume of the top region 25 is needed. Nevertheless, it is still of advantage to use the slide 11 to separate the mound 22 from the plastic foam flocks 3, 4 in this embodiment, which in turn will ensure that a constant volume is always available in the weighing container 7, irrespective of the quantity of plastic foam flocks 3, 4 with which it is filled, for the weighing process in order to measure the top region 25 when the bottom region 20 is removed from the weighing container 7.

At least one measuring unit may also be used with the embodiment illustrated in FIG. 2 as a means of detecting when the plastic foam flocks 3, 4 have reached the full level in the weighing container 7 so that the process of filling the weighing container 7 can be automatically interrupted as soon as a predefined full level is reached. This full level can also be used as a means of metering the quantity of plastic foam flocks 3,4 from the weighing container 7, e.g. by means of the data processing system 24, also enabling allowance to be made for the height of the mound 22, i.e. the effective filled height and the resultant filled weight can be corrected accordingly by this value.

Weighing containers 7or containers designed for detecting volume may be used as measuring containers with the apparatus 1 and their capacity may correspond to a multiple of, e.g. twice, the volume of the mould cavity 9 and/or the mixer 13. This means, amongst other things, that the time needed to measure the volumetric weight fractions and/or the subsequent mixing of the plastic foam flocks 3, 4 can be extended whilst maintaining a constant cycle time for the removal of finished plastic foam products 2 from the mould 10, so that the degree of standardisation of the mixture can be still further improved.

The part-volumes of the regions 20, 25 need not necessarily be completely filled, especially if it transpires that the quantity of one of the two flock fractions has to be reduced as a proportion of the other due to the volumetric weights of the plastic foam flocks 3, 4.

Although several supply containers 14, 15 for the binding agent are provided with the embodiment, it would naturally also be possible to use the methods described above as a means of bonding the plastic foam flocks 3, 4.

At this stage, it should also be pointed out that a separating mechanism, e.g. a slide 11, indicated by arrow 23, may also be inserted in the top region 25 in order to separate any mound 22 resulting from the second filling process and prevent it from being weighed.

Depending on which method is selected, the plastic foam flocks 3, 4 are transferred from the weighing container 7 in a single step or separately, i.e. in specific quantities of plastic foam flocks 3 and 4, one after the other to the mixer 13. In this respect, it is of advantage if the rate at which the mixer 13 is filled with the plastic foam flocks 3, 4 is adapted to the cycle time of the apparatus 1 and if the process of adding the binding agent, e.g. the prepolymer for a polyurethane foam, which may contain a single component such as a polyol which already contains a polyisocyanate component, or two components, is also adapted to the cycle time of the apparatus 1. This will prevent any premature admixing of the plastic foam flocks 3, 4 with the binding agent and thus prevent any premature hardening of the binding agent, for example due to a reaction with moisture in the ambient air, and hence reduce soiling, such as incrustation for example, of the mixer 13 and its moving parts, which means that longer periods may be left between cleaning. This approach has proved to be of particular advantage if the apparatus 1 is provided with a buffer container for ready raw material mixture comprising binding agent mixed with plastic foam flocks 3, 4 downstream of the mixer 13 so that the process of filling the mixer 13 with plastic foam flocks 3, 4 and/or binding agent can be adapted depending on how full the buffer container 30 is with raw material mixture.

It is also of advantage to use mixers 13 with a capacity that is such that it is not necessary to fill the entire volume of the mixer 13, as a result of which a pre-determinable array of spray nozzles may be provided for the binding agent in the region of the mixer 13 to enable a more thorough mixing of the binding agent with the plastic foam flocks 3, 4. It can also be an advantage not to place the spray nozzles for the binding agent directly on the mixing equipment, and instead to use screw conveyors for example, which will in turn reduce soiling of the mixing equipment.

The mixers 13 used with the embodiment illustrated in FIG. 2 may be of the same design as those used with the embodiment illustrated in FIG. 1, and in particular may be provided in the form of mixers equipped with outwardly and inwardly conveying mixing screws.

In addition to a control system 26 connected to the data processing system 24 and by means of which the specific proportion of plastic foam flocks 3, 4 can be introduced into the weighing container 7 on a controlled basis, it is also possible to provide, downstream of the supply containers 5, 6 for the plastic foam flocks 3, 4 and upstream of the mixer 13, a sorting system 27, e.g. a screen, in order to screen flocks of a specific size for example, which will further improve standardisation of the plastic foam product 2. Separated plastic foam flocks 3, 4 can then be forwarded to the mills, not illustrated in FIG. 2, for further crushing.

These sorting systems 27 may also be connected to the data processing system 24, as indicated, and may also be provided with a separate weighing device so that the proportion of separated plastic foam flocks 3, 4 can be quantified and optionally metered back into plastic foam flocks 3, 4 for the weighing container 7.

Also indicated by broken lines in FIG. 2, another supply container 28 is provided, which is used for other additives for example, or may also contain functional additives and fillers. The number of extra supply containers 18 and 28 is not limited to the embodiment illustrated here. Accordingly, it is also possible to incorporate flame-retarding agents, anti-bacterial additives or such like with the mixture of plastic foam flocks 3, 4. The ratio or proportion of binding agent is in the order of 1 to 20% by weight, preferably 1 to 5% by weight, for example 2 to 3% by weight of the proportion of plastic foam flocks 3, 4, 19, and this ratio may be varied depending on the quantity of other additives used. For example, these additives could both fulfil an additional function and assume the function of a binding agent to a certain extent, in which case the proportion of other binding agent may be reduced. Alternatively, it may be necessary to use additional binding agent for these additives as well and the line comprising supply container 28—mixer 13 and/or weighing container 7 may also include a separate weighing device (not illustrated in FIG. 2) for determining the proportional quantity of additives, which will also be connected to the data processing system 24 so that the weight of additives can also be taken into account if necessary when the quantity of added binding agent is calculated.

In view of the fact that the system of metering the plastic foam flocks 3, 4 is so accurate, however, it is not absolutely necessary to determine the proportion, i.e. quantity of binding agent.

If using liquid binding agents, valves 29 may be provided for example, which may also be connected to the data processing system 24 and controlled on a time-regulated basis so that the quantity of binding agent in the released volumetric flow and the timing with which the valves 29 are opened can also be calculated.

In plants operating on a continuous basis, it is also possible to set the system up so that a constant volumetric flow is fed through these valves 29 and delivered to the mixer 13.

As also indicated by broken lines in the embodiment illustrated in FIG. 2, a buffer container 30 may be provided between the mixer 13 and the mould 10. The size of this buffer container 30 may such that it will reliably fill two to three mould cavities 9. This being the case, an additional weighing device 31 may be provided between the buffer container 30 and the mould 10 so that the filling weight for the mould cavity 9 can be determined so that a constant filling quantity is constantly held ready. To this end, this other weighing device may also be connected to the data processing system 24.

Alternatively, instead of the weighing mechanism, it would also be possible to use a gating system, operated on a time-controlled basis, in which case control of the timing can be assumed by the data processing system 24, so that the filling quantity for the mould 10 can be determined and controlled on the basis of the time during which the gate is left open and the specific volumetric flow of mixture conveyed. This approach is possible in particular because, as a result of the method proposed by the invention, a mixture of a substantially standard volumetric weight is already waiting in the buffer container 30 and it is only the filling volume or filling weight which needs to be determined.

Another possible way of determining the filling volume is to use conveyor mechanisms or metering mechanisms which automatically meter a constant filling volume. For example, a star feeder gate system may be provided, either between the mixer 13 and the mould 10 or between the mixer 13 and the buffer container 30 or between the mould 10 and the buffer container 30, and, in a known manner, every compartment of the star feeder will contain a constant volume. This will provide a very accurate metering system, enabling the filling process to be operated simultaneously in several steps. Under certain circumstances, the binding agent may have been already added to the flocks 3, 4, 19 and in order to prevent it from sticking to them, the star feeder gate system, in particular the star feeder, may therefore be coated with Teflon, for example.

As mentioned above, in another option, the plastic foam flocks 3, 4, 19 are not mixed with the binding agent until they reach the mould 10 or shortly before they reach the mould 10. Yet again, the use of a star feeder for metering purposes, for example, has the advantage of being very accurate, although the star feeder itself will not have said coating.

Other buffer containers 30 and weighing mechanisms 31 may be incorporated in the apparatus 1 proposed by the invention. For example, it would be possible to provide buffer containers between the weighing container 7 and the mixer 13. Another option is to provide a coarse weighing system for the plastic foam flocks 3, 4 upstream of the weighing container 7 for each individual supply container 5, 6, 18, and the final, more accurate weighing process will take place in the weighing container 7.

All of the methods described above may be used for filling the mould 10 and for mixing the plastic foam flocks 3, 4, 19 with the binding agent and, likewise, any other optional additives which might be used can be added by any of the methods described above, in which case it may be possible to dispense with the mixer 13, for example if a nozzle system is used to deliver the binding agent directly into the mould cavity 9. This variant of the filling methods and the mixing methods may, of course, also be used with all the other embodiments described below.

It is also of advantage to use a star feeder gating system to convey the raw material mixture of plastic foam flocks 3, 4 with binding agent from the mixer 13 or the buffer container 30 into the filling pipe for the mould cavity 9 of the mould 10, in which case a drive mechanism of the star feeder gating system can be connected to the data processing system 24 so that a predeterminable variable speed of the star feeder can be obtained during the process of filling the mould cavity. This variable speed can be pre-set or pre-adjusted depending on the mould cavity 9 and the plastic foam product 2 and air may be used as the conveying medium in particular to fill the mould cavity 9 with the raw material mixture and the pressure of this conveying medium, i.e. the pressure with which the mould cavity is filled, can be adapted to the specific plastic foam product 2 and/or the speed of the star feeder.

To increase the accuracy of the product properties of the plastic foam products 2 still further and as an additional control option, it is also possible to operate a weighing process after the plastic foam flocks 3, 4, 19 have been mixed with the binding agent. This can be achieved by providing an additional weighing container or alternatively by fitting the mixer 13 with a weighing mechanism, for example. This will enable the metered quantity of binding agent to be determined, which the data processing system 24 can use as a basis for controlling the opening of the valves 29.

Depending on the type of plastic foam products 2, for example mouldings or blocks of foam, for which the apparatus 1 is used, either a tool is provided to produce a plastic foam product 2 for every apparatus 1 or, in another option, several tools. i.e. moulds 10, are disposed on a rotary table and these moulds 10 are fed to and brought into engagement with the filling pipe in a pre-set timed cycle so that the raw material mixture can be delivered to the mould cavity. It has been found to be of particular advantage if mechanisms are incorporated in the apparatus 1 for delivering the reaction medium for the binding agent, for example steam, which will enable an at least almost constant delivery of the reaction medium into the mould cavity, independently of the cycle time.

It is also of advantage if appropriate precautions are taken with respect to the apparatus 1 to ensure that the filling elements used to fill the mould cavity 9 with the raw material mixture of plastic foam flocks 3, 4 and binding agent are cleaned between the individual filling processes. In particular, the raw material mixture is at least partially removed from the filling element.

Finally, it is also possible to operate a weighing process directly in the mould 10. With the aid of differential weighing processes, the proportion of the respective fraction of plastic foam flocks 3 or 4 can then be determined and the quantities of foam flocks 3 and 4 which will have to be metered for the next cycle can be calculated by means of the data processing system. This being the case, it would be possible to dispense with the weighing container 7 altogether.

As mentioned above, another possibility is to mix the plastic foam flocks 3, 4, 19 directly in the mould 10, in which case, ultimately, the mixer 13 is also not absolutely necessary. For this variant of the apparatus proposed by the invention, therefore, the plastic foam flocks 3, 4, 19 and the binding agent are metered directly into the mould cavity 9 and the appropriate conveyor systems, described above, are provided accordingly.

Instead of using individual lines linking up the data processing system 24, it would also be possible to install a bus system.

Although the data processing system 24 is not shown in the other embodiments in order to retain clarity, it may naturally be configured to control and/or regulate individual components of the system and the plant as a whole.

FIG. 3 illustrates an embodiment of the apparatus 1 proposed by the invention which uses a free-fall mixing run 32 for mixing the plastic foam flocks 3 from the supply container 5. In order to simplify the diagram, only one supply container for plastic foam flocks 3 is illustrated but it goes without saying that several supply containers 5 may be provided and this embodiment may also be used with standard plastic foam flocks 3 as explained above, although this latter case is not restricted to the use of the free-fall run 32.

The plastic foam flocks 3 are delivered by appropriate conveyor means, e.g. blower pipes, continuous conveyors such as vibrating conveyors, belt conveyors, etc., to the free-fall mixing run 32 in an upper region 33. In the same way as explained above, the requisite weighing device may be provided between the free-fall mixer run 32 and the supply container 5, for example for weighing several different fractions, thereby enabling the corresponding desired volumetric weight of the plastic foam flock mixture to be prepared (not illustrated in FIG. 3).

The binding agent from the supply container 14 and if necessary other additives from the supply container 28 are delivered to the free-fall mixing run 32. If using several additives, these may be mixed with one another beforehand with the aid of an appropriate mixing mechanism 34, e.g. an agitator, particularly if using at least one liquid additive, and it would also be possible to mix them with the binding agent by means of mixing devices 34 (not illustrated in FIG. 3), so that a ready mixture of binding agent and additives is essentially available at the free-fall mixing run 32.

The mixing process in the mixing devices 34 may be operated by means of agitators or by screws by blasting in air or similar.

As illustrated in FIG. 3, several inlet system 36 for the binding agent and/or the additives or the mixture of binding agent and/or additives may be provided along a length 35 of the free-fall mixing run 32 to ensure that the plastic foam flocks 3 are thoroughly mixed with binding agent and/or additives along the length 35 of the free-fall mixing run 32. If the binding agent and/or the additives are used in liquid form, the inlet system 36 may be provided in the form of nozzles, for example. Accordingly, a sort of mist is generated across a width 37 of the free-fall mixing run 32, so that a ready mixture is produced by the free-fall mixing run 32 as the plastic foam flocks 3 pass along the route from their inlet in the region 33 of the free-fall mixing run 32 to the outlet at the region 38.

If using powdered binding agent and/or additives, the inlet for these may be provided in the form of an air conveying system and appropriate nozzles.

If liquid binding agent and/or additives are used, another possibility is to provide a separating device 39, e.g. perforated plate, a screen or similar in the free-fall mixing run 32, indicated by dotted-dashed lines, to allow surplus liquid to drain out so that it can then be delivered back to the free-fall mixing run 32 as indicated by the dotted-dashed line 40 for further processing. Likewise, as also indicated by broken lines, a press 41 may be provided between the buffer container 30, disposed between the free-fall mixing run 32 and the mould 10, for example, by means of which surplus binding agent and/or surplus additives can be removed from the plastic foam flocks. This press 41 may be provided in the form of a roll press, for example. The separated binding agent and/or the separated additives can then be recycled, as illustrated, either to the free-fall mixing run 32 directly, where it can be used again, or to the supply containers 28 or 14.

The buffer 30 container again preferably has a star feeder gating system, so that the mould 10 can be reliably filled with a constant volume of mixture. However, it is not necessary to provide the buffer container 30 and the mixture of plastic foam flocks 3 with binding agents and/or additives, can be delivered directly into the mould cavity 9.

Alternatively, it would also be possible for the outlet of the press 41 for the plastic foam flocks 3 mixed with binding agents and/or additives to open directly into the mould cavity 9.

Again with this embodiment and the other embodiments described with reference to the other drawings, appropriate conveyor systems, such as gravity pipes, blower pipes, filling pipes, screw conveyors, etc., are provided between the individual components of the apparatus 1, but are not illustrated as they are within the reach of the person skilled in this field, who will know what conveyor systems will best suit his specific purpose.

FIG. 4 provides a partial illustration of an embodiment of the apparatus 1 proposed by the invention, although some of the components of the apparatus 1 already described above, e.g. the weighing container 7, have been left out and reference should be made to the explanations given above for details of their design and layout.

In this embodiment, a screw mixer 42 is used for mixing the plastic foam flocks 3 from the supply container 5 with the binding agent from the supply container 14. The plastic foam flocks 3 are delivered to the screw mixer 42 by means of a conveyor belt, for example, or, if other additives have already been added, to a pre-mixer, which may also be provided in the form of a screw mixer, for example. Disposed along a length 43 of the screw conveyor is at least one inlet system 44, e.g. a nozzle, for spraying the binding agent. Naturally, it would also be possible to provide several inlet systems 44 for the binding agent and/or for extra additives. As a result of the length 43 of the screw mixer 42, a very homogeneous mixture of the plastic foam flocks 3 with the binding agent and/or the additives can be obtained.

In this embodiment, it is also possible to use counter-rotating screws on a shaft and another option would be to provide several shafts with opposite screw channels, as described above.

The ready mixture leaves the screw mixer 42, optionally via an intermediate buffer container (not illustrated in FIG. 4), to pass through a metering device 45 which again is a star feeder in the embodiment illustrated in FIG. 4, either directly or via blower pipes to pass through other screw conveyors, slide filling systems, etc.

Finally, FIG. 5 illustrates another embodiment of the apparatus 1 proposed by the invention, in which the mould 10 itself operates as a weighing container 7 and to which the foam plastic flocks 3, 4 are delivered from supply containers 5, 6, as well as the binding agent from the supply container 14. The plastic foam flocks 3,4 are preferably conveyed using air as a conveying medium and can be blasted through the orifices 46, indicated by broken lines, into the mould cavity 9, for example. Naturally, it would be possible to provide separate filling orifices. The orifices 46 may also be used to introduce a reaction medium, e.g. steam or similar, and can simultaneously be used to allow the conveyor air to flow out. By preference, several orifices 46 are arranged distributed on the surface of the mould 10.

Instead of using a binding agent, it is also possible, especially if using hot air as the conveying medium, to melt the plastic foam flocks 3, 4 directly. In this case, it can be of advantage under certain circumstances not to wait until the mould 10 to make up the composition for the foam product but to do this beforehand between the supply containers 5, 6 and the mould 10, e.g. by providing weighing devices such as the weighing container 7.

Since, with all of these embodiments, there is a possibility that a certain amount of dust will get into the volumetric weight fractions due to the crushing process, a dust screen may be provided after the crushing devices or before the weighing container 7, and a separate one is preferably provided for each supply container 5, 6, 14.

A whole range of mouldings may be made with the apparatus 1 proposed by the invention and as a result of the invention these mouldings will have a very standard volumetric weight, i.e. a volumetric weight which varies within only narrow limits, provided the raw material mixture is not compacted during the production process. There may be a compaction process for the reasons explained above.

Plastic foam products, e.g. mouldings, may also be produced which are particularly suitable for noise insulation. Accessory parts may also be made for the automotive industry, for example, and these parts may be covered with a facing, e.g. a non-woven material, which is “back injected” with the plastic foam flock/binding agent mixture. This facing may be applied before filling the mould cavity, where it can be held in place by applying a vacuum, for example, in order to prevent the facing slipping during the filling process.

The “back injection” may be operated by blasting the plastic foam flocks 3, 4 mixed with the binding agent into the mould cavity. This being the case, it is possible to produce a so-called heavy and a so-called light layer of the plastic foam flock/binding agent mixture for a so-called spring/mass system, and this can be done in particular by varying the pressure of the air used as the conveying medium, in other words the filling pressure and/or the speed of the filling process.

Alternatively, it would also be possible to use one raw material mixture for the heavy layer that is different from the raw material mixture used for the light layer, including rubber granulate mixtures for example, in which case specific known additives, with which the skilled person will be familiar, may be added to this rubber granulate. In another option, the heavy layer may be made by interrupting the filling process and the plastic foam flocks 3, 4 already introduced could then be compacted by various means, e.g. punches, at least in certain regions of the mould cavity.

Instead of using a non-woven material, it would also be possible to use other types of facings, e.g. carpets, for example to make parcel shelves for passenger cars, and the details given with respect to the facing materials should therefore not be construed as being restrictive.

For the sake of good order, it should finally be pointed out that in order to provide a clearer understanding of the apparatus 1, it and its constituents parts are illustrated in certain parts out of scale and/or on a larger scale and/or on a reduced scale.

The independent solutions proposed by the invention to achieve the objective may be found in the description.

Above all, the individual embodiments and features illustrated in FIGS. 1; 2; 3; 4; 5 may be construed as being subject matter forming independent solutions proposed by the invention. The associated objectives and solutions may be found in the detailed descriptions of these drawings.

List of reference numbers

| | |
|---|---|
| 1 | Apparatus |
| 2 | Plastic foam product |
| 3 | Plastic foam flock |
| 4 | Plastic foam flock |
| 5 | Supply container |
| 6 | Supply container |
| 7 | Weighing container |
| 8 | Weighing container |
| 9 | Mould cavity |
| 10 | Mould |
| 11 | Slide |
| 12 | Slide |
| 13 | Mixer |
| 14 | Supply container |
| 15 | Supply container |
| 16 | Polyol |
| 17 | Polyisocyanate |
| 18 | Supply container |
| 19 | Plastic foam flock |
| 20 | Region |
| 21 | Line |
| 23 | Mound |
| 23 | Arrow |
| 24 | Data processing system |
| 25 | Region |
| 26 | Control system |
| 27 | Sorting system |
| 28 | Supply container |
| 29 | Valve |
| 30 | Buffer container |
| 31 | Weighing device |
| 32 | Free-fall mixing run |
| 33 | Region |
| 34 | Mixing system |
| 35 | Length |
| 36 | Inlet system |
| 37 | Width |
| 38 | Region |
| 39 | Separating device |
| 40 | Line |
| 41 | Press |
| 42 | Screw mixer |
| 43 | Length |
| 44 | Inlet system |
| 45 | Metering system |
| 46 | Orifice |

1. Method of producing plastic foam products from plastic foam flocks, in particular from recycled plastic foam flocks, whereby plastic foam flocks of a predeterminable size and/or of a different volumetric weight are mixed in a predeterminable mixing ratio and are bonded to one another by surface melting and/or by means of at least one binding agent, optionally in a mould, characterised in that plastic foam flocks of a first volumetric weight fraction with volumetric weights that are at least predominantly greater than or the same as a desired volumetric weight of the plastic foam product are introduced into a measuring device with a defined weight or with a defined volume and the total volume or total weight thereof is measured, and plastic foam flocks of a second volumetric weight fraction with volumetric weights that are at least predominantly lower than or the same as the desired volumetric weight of the plastic foam product are introduced into the same or a different measuring device also with a defined weight or defined volume and the total volume or total weight thereof is measured, or the total weight or total volume of the two volumetric weight fractions are weighed jointly after an individual measurement has been taken of the first volumetric weight fraction, and the variance of the actual volumetric weight of the plastic foam product form the desired volumetric weight is determined from the resultant data.

2. Method as claimed in claim 1, characterised in that the quantity or volume of a volumetric weight fraction for the plastic foam product in the measuring device is increased or reduced on the basis of the resultant data.

3. Method as claimed in claim 1 or 2, characterised in that the resultant data for producing another plastic foam product is used as a basis for adjusting the ratio by quantity or volume of the volumetric weight fractions relative to one another, depending on the variance from the desired weight.

4. Method as claimed in one of the preceding claims, characterised in that the surface melting of the plastic foam flocks is effected by means of warm or hot air.

5. Method as claimed in one of claims 1 to 3, characterised in that the hot air is at least partially used as conveying air for the plastic foam flocks.

6. Method as claimed in one of claims 1 to 3, characterised in that the binding agent is formed from the plastic foam flocks by reacting at least one functional group of the foam molecules by passing a reactive gas over them.

7. Method as claimed in one of the preceding claims, characterised in that the plastic foam flocks are mixed with the binding agent or binding agent mixture by spraying onto the plastic foam flocks in a screw mixer.

8. Method as claimed in claim 7, characterised in that the mixing takes place in a screw mixer with counter-rotating mixing screws disposed on at least one shaft.

9. Method as claimed in one of claims 1 to 3, characterised in that the plastic foam flocks are mixed with the binding agent or binding agent mixture in a free-fall system.

10. Method as claimed in one of claims 1 to 3, characterised in that the plastic foam flocks are mixed with the binding agent or binding agent mixture by spraying the binding agent or binding agent mixture into a mould cavity of the mould.

11. Method as claimed in one of the preceding claims, characterised in that a weighing container is used to determine the volumetric weight, which enables at least one volumetric weight fraction to be determined separately, whereby a proportion of plastic foam flocks exceeding a defined part-volume of the weighing container is separated and only the proportion of plastic foam flocks corresponding to the defined part-volume is weighed.

12. Method as claimed in one of the preceding claims, characterised in that at least one star feeder is used to meter the plastic foam flocks and/or the plastic foam flocks/binding agent mixture into the mould.

13. Method as claimed in one of the preceding claims, characterised in that a polyurethane prepolymer is used to adjust the hardness of the plastic foam product, the content of isocyanate groups being fixed depending on a desired hardness.

14. Apparatus for producing a plastic foam product from plastic foam flocks with several supply containers for pieces or flocks of plastic foam, optionally with a crushing device disposed upstream and/or downstream of the supply containers, at least one measuring container, optionally at least one supply container for at least one binding agent and/or other additives, as well as a mould, upstream of which a mixer and/or at least one buffer container is optionally disposed, characterised in that the measuring container is designed to sense separately the total weight or the total volume of individual different volumetric weight fractions of the plastic foam flocks (3, 4, 19).

15. Apparatus as claimed in claim 14, characterised in that at least one separating device, e.g. a slide (11), is provided in or on the measuring container, by means of which a defined part-volume of the total volume of the measuring container can be separated.

16. Apparatus as claimed in claim 15, characterised in that the measuring container is designed so that the weight or the volume of a content of the part-volume can be determined independently of a total weight of the measuring container which may optionally be completely filled.

17. Apparatus as claimed in claim 16, characterised in that a part of the measuring container defining the part-volume is designed so that it can be mechanically separated from the remaining part of the measuring container.

18. Apparatus as claimed in one of the preceding claims 14 to 17, characterised in that the mixer (13) is provided in the form of a screw mixer (42) or a free-fall mixer or a static mixer or an electrostatic mixer.

19. Apparatus as claimed in claim 18, characterised in that the screw mixer (42) has at least one, in particular two screw shafts with counter-rotating, i.e. inwardly and outwardly conveying, screw channels.

20. Apparatus as claimed in one of the preceding claims 14 to 19, characterised in that a metering device (45) is provided upstream of the mould (10), which is provided in the form of a star feeder, for which a variable speed may be set if necessary, in particular at a drive mechanism of the star feeder.

21. Apparatus as claimed in one of the preceding claims 18 to 20, characterised in that the screw mixer (42) has at least one spray nozzle for introducing a binding agent or binding agent mixture and/or at least one additive.

22. Apparatus as claimed in one of the preceding claims 14 to 21, characterised in that a buffer container (30) is provided between the mixer (13) and the mould (10) with a capacity which corresponds at least to the volume of a mould cavity (9) of the mould (10).

23. Apparatus as claimed in claim 22, characterised in that the capacity of the buffer container (30) corresponds to a whole-number multiple of the volume of the mould cavity (9).

24. Apparatus as claimed in claim 22 or 23, characterised in that a weighing device or a metering device, e.g. a star feeder, co-operates with the buffer container (30).

25. Apparatus as claimed in one of the preceding claims 14 to 24, characterised in that the mould (10) is provided with at least one mechanism for distributing a binding agent, e.g. a spray nozzle.

26. Apparatus as claimed in one of the preceding claims 14 to 25, characterised in that the mould (10) is provided with a system for creating a vacuum in the mould cavity (9).

27. Apparatus as claimed in one of the preceding claims 14 to 26, characterised in that the mould (10) is designed as a weighing container (7) and/or mixer (13).

28. Apparatus as claimed in one of the preceding claims 14 to 27, characterised in that the measuring container is provided with at least one measuring unit by means of which the level of the plastic foam flocks (3, 4, 19) in the measuring unit can be determined.

29. Measuring container for determining the weight or the volume of a defined volume or weight of a filling, e.g. plastic foam flocks, with a measuring unit volume defined by a casing, a base and a cover, characterised in that at least one separating device,. e.g. a slide (11), is provided, by means of which the measuring unit volume can be divided into defined part-volumes.

30. Measuring container as claimed in claim 29, characterised in that the separating device is disposed horizontally and co-operates with the casing.

31. Measuring container as claimed in claim 29 or 30, characterised in that the parts of the measuring container defining at least a part-volume can be mechanically separated from the other parts of the measuring container.

32. Measuring container as claimed in one of claims 29 to 31, characterised in that a weighing device co-operates with at least a part-volume.

33. Plastic foam product, in particular a moulding, which can be made by a method as claimed on claims 1 to 13.

34. Plastic foam product made from plastic foam flocks, in particular recycled plastic foam flocks, of different volumetric weights bonded to one another by means of a single- or multi-component binding agent, characterised in that a proportion of binding agent relative to a proportion of plastic foam flocks is in the range of between 1% by weight and 5% by weight, preferably in the range of between 2% by weight and 4% by weight, in particular 3% by weight.

35. Plastic foam product as claimed in claim 33 or 34, characterised in that a facing is provided on at least one surface.

36. Plastic foam product as claimed in claim 35, characterised in that the facing is a non-woven material, carpet or felt.

37. Plastic foam product as claimed in one of claims 33 to 36, characterised in that at least a part-volume has a higher density than the remaining volume.

38. Plastic foam product as claimed in claim 37, characterised in that the compacted part-volume is a heavy layer for a mass-spring system of a sound absorber.

39. Plastic foam product as claimed in claim 38, characterised in that the heavy layer is at least partially made from a rubber granulate.
